(19) United States
(12) Patent Application Publication
(10) Pub. No.: US 2003/0026875 A1
(43) Pub. Date: Feb. 6, 2003

(54) Multi-compartment pet food container

(76) Inventors: Carlos A. Aguilar, St. Joseph, MO (US); Mario Albuja, St. Joseph, MO (US); Dan Dixon, St. Joseph, MO (US); Harold H. Bennett, St. Joseph, MO (US); Marc Dambrine, Ailly-S/Somme (FR); Michael G. Rayner, St. Joseph, MO (US)

Correspondence Address: BELL, BOYD & LLOYD LLC, P. O. BOX 1135, CHICAGO, IL, 60690-1135, US

(21) Appl. No.: 09/682,177

(22) Filed: Jul. 31, 2001

(51) Int. Cl. A23B 4/00

(52) U.S. Cl. 426/120

(57) ABSTRACT

An improved pet food snack and container for holding same and for providing and dispensing a dry pet food snack in combination with a highly palatable paste or sauce is provided. The container includes a tray, a dry food compartment formed in the tray having a unit of dry pet food and a wet food compartment formed in the tray having a quantity of wet pet food. The dry pet food compartment is spatially adapted to maintain a number of dry pet food units in a packaged order. The wet pet food compartment is preferably moisture impermeable. The wet pet food is preferably a flavored cream paste, includes oils and fats and is shelf stable.

### BACKGROUND OF THE INVENTION

The present invention relates generally to pet food. More particularly, the present invention relates to pet food containers including pet food.

A variety of pet food products are available to consumers. These products range from products providing complete nutritional support to snacks. These products are available in a variety of shapes, sizes and forms. Pet food and to a certain extent pet food snacks are adapted to provide complete nutrition to the pet. Certain pet foods are further adapted to improve immunity to or fight or control disease. While nutrition is one important factor, the pet food and pet food snacks should be palatable, so that the pet consumes the required amount necessary for proper nutrition. A pet owner is unlikely to repeatedly buy pet food or pet food snacks that the pet will not eat.

Canned or high moisture pet food products, containing meat and typically having a moisture content above fifty percent by weight are usually more palatable than dry pet food.

However, dry pet food is a highly nutritional form of pet food. The relatively low moisture content of dry pet food permits a higher degree of nutritional balancing of ingredients. Moreover, dry pet food provides benefits to the dental hygiene of pets. In this regard, the action of biting and chewing dry pet products helps to remove tartar from the teeth of pets.

Dry pet food also provides other advantages. Dry pet food is typically less expensive than a similar quantity of wet pet food. The dry pet food also stays fresher for a longer period of time, which allows the pet owner to leave a portion of the dry pet food exposed to the pet for a longer period of time.

A variety of efforts have been made to make dry pet food more palatable to pets. Likewise, a variety of efforts have been made to make dry pet food more desirable to pet owners. For example, the pet food industry has added palatability enhancers to the dry food. While such product enhancers have been effective, a need continuously exists to improve the palatability of dry pet food and the popularity of dry pet food snacks.

### SUMMARY OF THE INVENTION

The present invention provides an improved pet food snack. More specifically, the present invention provides methods and products for providing and dispensing a dry pet food meal or snack in combination with a wet meal component, a highly palatable paste or sauce or a functional ingredient.

To this end, in an embodiment of the present invention, a pet food container including pet food is provided. The container includes a tray, a dry food compartment formed in the tray including a unit of dry pet food and a wet food compartment formed in the tray including a quantity of wet pet food.

In an embodiment, the dry pet food compartment is spatially adapted to maintain a number of dry pet food units in a packaged order.

In an embodiment, the dry pet food comprises a powdered meal supplement. The supplement preferably includes a functional ingredient. The functional ingredient in an embodiment includes a probiotic micro-organism, or a moiety of its culture. Such moiety in an embodiment includes a cell fragment, a metabolite or a supernatant of its culture.

In an embodiment, thewet pet food is a flavored cream paste.

In an embodiment, thewet pet food includes oils and fats.

In an embodiment, the wet pet food is shelf stable.

In an embodiment, the wet pet food includes a functional ingredient. The functional ingredient in an embodiment includes a probiotic micro-organism or a moiety of its culture. Such moiety in an embodiment includes a cell fragment, a metabolite or a supernatant of its culture.

In an embodiment, thecontainer includesa second wet food compartment formed in the tray having a quantity of a second wet pet food.

In an embodiment, thecontainer includes a resealable lid.

In another embodiment of the present invention, a pet food container is provided. The pet food container includes a tray and a plurality of pet food compartments formed in the tray. The pet food compartments are individually spatially adapted to hold a particular quantity and type of pet food. At least one compartment is moisture impermeable and thereby adapted to hold a quantity of wet pet food without leaking. The container also includes a resealable lid removably attached to the container. The lid is adapted to seal the compartments from ambient air.

In an embodiment, the tray is plastic.

In an embodiment, the tray is fiber-based, e.g., the tray may be of fiberboard, cardboard or barrierboard, or of a laminate including the one of the same.

In an embodiment, the resealable lid is adapted to individually seal each compartment.

In a further embodiment of the present invention, a pet food product comprises a container defining at least two airtight compartments for the separate storage of separated meal components and different meal components separately stored in the respective compartments.

In an embodiment, one of the components is a dry pet food or treat and the other component is a flowable foodstuff or food supplement. The supplement in an embodiment includes a microorganism or a metabolic moiety thereof.

In an embodiment, the container is a pouch.

In an embodiment, the container includes at least one removable separating device, so that the different meal components may be combined. The removable separating device allows for mixing of the separate components prior to dispensing or serving.

In an embodiment, the container includes a crease so that one pet food compartment may be folded over another pet food compartment.

In a still further embodiment of the present invention, a pet food container including dry and wet pet food is provided. The pet food container includes a unit of dry pet food stored in the tray. The dry pet food includes a surface that is designed to hold a quantity of wet pet food, which is also stored in the tray.

In an embodiment, the dry pet food product includes a body that has a rectangular shape.

In an embodiment, the dry pet food product is shaped to define a scoop. The product in an embodiment has a spoon shape.

In a further embodiment of the present invention, a method for providing a pet food product is provided. The method includes the step of providing a container that houses a plurality of pet foods. The container includes a quantity of dry pet food units and a quantity of a first wet pet food. The dry pet food units have a surface adapted to hold a quantity of the first wet pet food. The method includes the steps of enabling a consumer to grasp and remove a dry pet food unit and use the dry pet food unit to remove a quantity of the first wet pet food and present the dry pet food unit with the wet pet food to a pet.

In an embodiment, the method includes the further step of enabling the consumer to use the dry food unit to remove a quantity of a second wet pet food.

An advantage of the present invention is to provide improved pet food snacks.

Another advantage of the present invention is to provide improved pet food containers.

Furthermore, an advantage of the present invention is to provide an improved pet food including a dry pet food component and a wet pet food component.

Still further, an advantage of the present invention is to provide a convenient and attractive method of providing pet food products to a consumer.

Moreover, an advantage of the present invention is that it provides a complete product that allows the consumer to provide their pet with a wet pet food product without the need for utensils. It provides a means for taking components of a complete meal or snack in a portable configuration that is conveniently preparable by a traveler.

Further, an advantage of the present invention is that it provides a more palatable dry pet food.

Additional features and advantages of the present invention will be described in and apparent from the detailed description of the presently preferred embodiments.

### BRIEF DESCRIPTION OF THE DRAWINGS

FIG. 1 is a perspective view of a pet food container of the present invention having a tray defining a plurality of pet food compartments.

FIG. 2 is a perspective view of a pet food container of the present invention having a tray with a plurality of different pet foods.

FIG. 3 is a perspective view of a dry pet food unit of the present invention.

FIG. 4 is a perspective view of a dry pet food/wet pet food combination of the present invention.

FIG. 5 is perspective view of another embodiment of the present invention.

FIG. 6 is a perspective view of a further embodiment of the present invention.

FIG. 7 is a perspective view of a still another embodiment of the present invention.

### DETAILED DESCRIPTION OF THE INVENTION

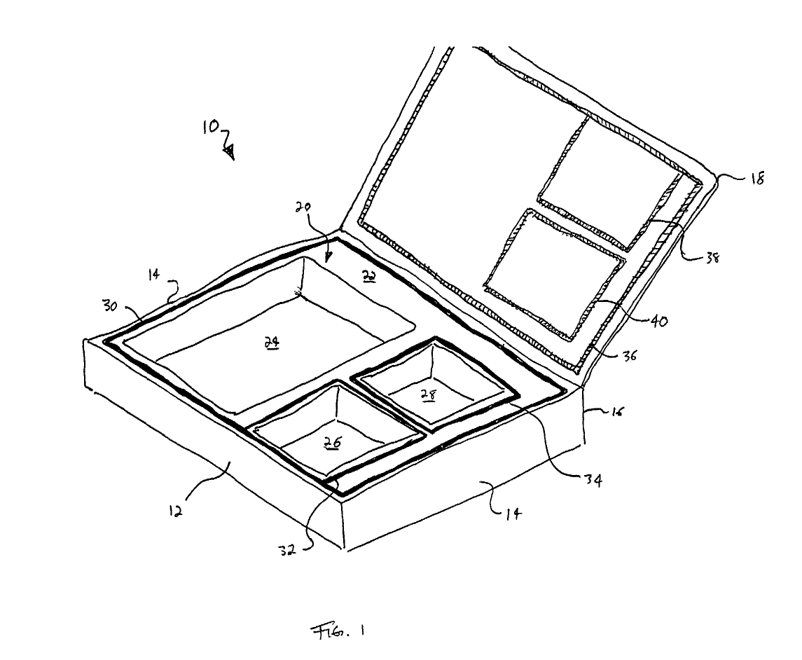

Referring now to FIG. 1, a perspective view of an embodiment of a multiple compartment pet food container 10 of the present invention is illustrated. The container 10 includes a front 12, a plurality of sides 14, a back 16 and a resealable lid 18. In the embodiment illustrated, the lid is adaptable to be opened via a hinge. However, if desired, the lid can be constructed so that it is completely removed. The front 12, sides 14, back 16 and lid 18 are adaptable to be made of any material. For example, the container 10 can be made of a fibrous material such as cardboard, fiberboard, barrierboard, be made of plastic or include a laminate that is made of one of the same. The shape and relative dimensions of the container 10 can vary from the illustrated embodiment, i.e., a generally flat and rectangular container 10, without departing from the scope of the invention. For example, if desired the container 10 can be square or oval.

In the illustrated embodiment, the front 12, sides 14 and back 16 support a tray 20. The tray 20 includes a tray surface 22 and a plurality of separate compartments 24, 26 and 28, which project downwardly into the container 10 from the tray surface 22. The tray surface 22 and the compartments 24, 26 and 28 are preferably formed as one piece via a suitable molding process. The tray is made of plastic or other suitable impermeable material that is suitable to support wet pet food. The tray 20 can also include other attachments or structural members, which are not illustrated, but which enable the container 10 to fix the tray 20 in place and aid the tray 20 in supporting the pet food products described herein.

The compartments 24, 26 and 28 preferably define a volume adapted to support the quantity of pet food product that they are intended to hold. Accordingly, different compartments have different lengths, widths and depths. The compartments are adaptable to have the substantially square or rectangular contours, as illustrated, or to have other straight sided or rounded contours. Although the container 10 is illustrated as having three compartments, the container 10 can have any number of compartments and preferably at least two.

In the illustrated embodiment, the compartment 24 is larger than compartments 26 and 28 and is adapted to hold or package dry pet food and preferably dry pet food having a predetermined shape. The shape and depth of the compartment 24 is preferably adapted to receive a predetermined number of dry food units or other measurement of the dry food, such as a particular weight.

The compartments 26 and 28 are both spatially adapted to hold or package a predetermined quantity of wet pet food and preferably a sauce, paste or shredded wet pet food. The compartments 26 and 28 may be of different sizes to hold more or less of a certain sauce, paste or shredded food and of different shapes to accommodate wet pet foods of different thicknesses. The compartments 26 and 28 are either plastic or otherwise coated with a moisture impermeable coating such as a thin plastic film or wax. The wet food compartments 26 and 28 impermeably hold wet pastes or sauces having any moisture content percentage by weight, including percentages substantially above fifty percent.

As noted above, the container 10 includes a resealable lid 18. The resealable lid 18 is adapted to enable the consumer to open the lid 18, remove a portion of the pet food products from the container 10, close the lid 18 and form a seal that keeps ambient air from contacting the unused pet food portions. The container 10 is adaptable to employ many different known types of reusable seals for disposable containers.

In an embodiment, the tray surface 22 defines a continuous downwardly extending channel 30 that extends along the outer edges of the tray 20. The tray surface 22 defines a similar channel 32 that extends around the wet pet food compartment 26. As illustrated, the channel 32 engages the larger channel 30 along the front side of the wet food compartment 26. The channel 32 alternatively extends around each side of the wet food compartment 26. The tray surface 22 defines a similar channel 34 that extends around each side of the wet pet food compartment 28. The channel 32 alternatively extends around three sides of the wet food compartment 28 and mates with the larger channel 30 along the back side of the wet food compartment 28. Although not illustrated, the tray surface 22 can also define a similar channel around the dry food compartment.

In this embodiment, the lid 18 includes a continuous sealing rib 36, protruding from the inner surface of the lid 18, which extends along the outer edges of the lid 18. The lid 18 also includes a protruding rib 38 that extends in three directions in the interior of the lid 18 and engages the larger rib 36, to close the three sides. The protruding rib 38 alternatively has four sides, depending on the shape of the channel 32. The lid 18 further includes a protruding rib 40 that extends in four directions and forms an enclosed shape. The protruding rib 40 alternatively has three sides, depending on the shape of the channel 34.

The ribs of the lid 18 are each slightly wider than the channels of the tray 20. The ribs are also made of a suitably deformable material, such that the ribs press-fit into the channels to form a seal. The amount of deformation and the frictional characteristics of the materials are designed such that the consumer can open the lid 18, using a reasonable amount of force. After opening the lid 18, the ribs are flexible enough so that they expand to their original shape to allow the consumer to reseal the lid 18.

In this embodiment, when the consumer closes the lid 18 onto the tray 20 of the container 10, the rib 36 mates with the channel 30 and substantially seals the entire tray surface 22. Further, when the consumer closes the lid 18, the rib 38 mates with the channel 32 and seals the wet food compartment 26, and the rib 40 mates with the channel 34 and seals the wet food compartment 28. It should be appreciated that other seal embodiments would likewise be adaptable to seal the entire tray and/or individual compartments.

In the illustrated embodiment, the container 10 substantially seals the entire tray surface 22 and any pet food contained therein via the rib 36/channel 30 interface. The container 10 also individually seals the wet pet food compartments 26 and 28, via their respective rib/channel interfaces, so that wet food cannot run onto the tray surface 22 and into the other food compartments, etc. The container 10 also includes individually sealing the dry pet food compartment 24 in the manner herein described, so that chips, crumbs or small pieces of dry pet food cannot slide into open spaces between the tray surface 22 and the inner wall of the lid 18. If desired, the lid can be designed so as to only seal the tray surface 22 and not individually seal the wet pet food compartments 26 and 28. For example, the lid can seal the tray surface 22 when the wet foods are paste-like versus sauce-like and are thick enough not to separate and/or run out of and into the other compartments.

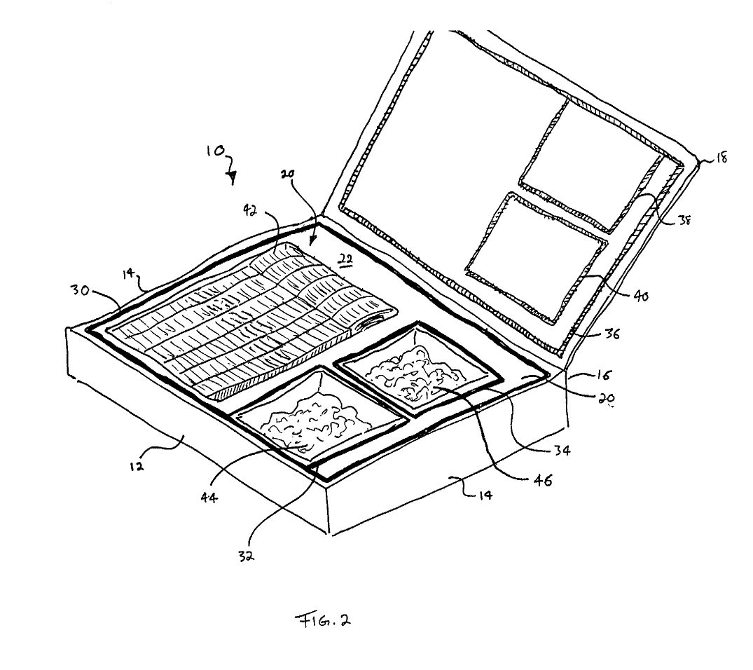

Referring now to FIG. 2, the container 10 is illustrated packaged or loaded with dry and wet pet food. The dry food compartment 24 includes a plurality of dry pet food dipping units 42, which are packaged side by side in an efficient and orderly manner. The wet food compartment 26 includes a quantity of wet pet food 44. The quantity of wet pet food 44 preferably enables the lid 18 to be closed without contacting and placing an excessive amount of force on the wet pet food 44. The wet food compartment 28 includes a similarly appropriate quantity of a different wet pet food 46.

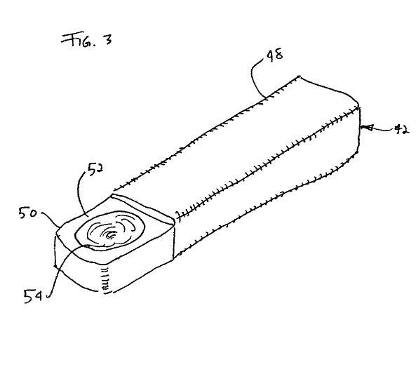

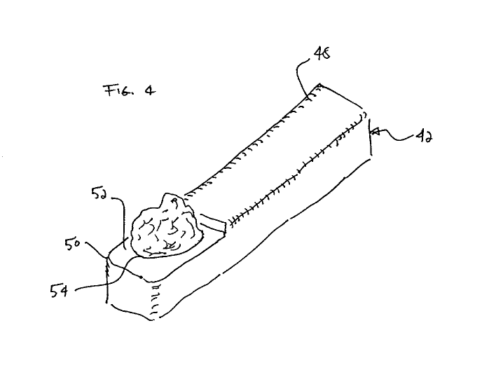

Referring now to FIGS. 3 and 4, perspective views of the dry dipping unit 42 alone and in combination with wet pet food are respectively illustrated. The dry food unit 42 is adaptable to be made from any known dry pet food components and in an embodiment is baked. The dry food in certain embodiments includes functional foods or food ingredients. The functional foods or ingredients include, among other items, vitamins, minerals, insoluble or soluble fibers, functional extracts and probiotic micro-organisms, moieties of their cultures, their cell fragments, supernatants of their cultures and other metabolic moieties. In an embodiment, the dry pet food includes a powdered meal supplement.

In the illustrated embodiment, the dry food unit 42 includes a handle portion 48 and a dipping portion 50. A variety of shapes and designs can be used for the dry food unit 42. For example, if a spoon shape is desired, the handle portion 48 can have a circular, elliptical, square, rectangular or other shaped cross-section and a flat or rounded end. In a preferred embodiment, the handle portion 48 as well as the middle between the handle and dipping portions are rectangular and have flat sides. The dipping portion 50 can include a partially circular, elliptical, square, rectangular or other shaped cross-section and a flat or rounded end. In a preferred embodiment, the dipping portion 50 is also preferably rectangular and has flat sides and a flat end. The dipping portion 50, however, also includes one or both of a flat dipping surface 52 and/or an indentation 54, which in one preferred embodiment is spoon shaped and defined by a rectangular dipping portion 50.

The flat surface 52 and the indentation 54 are adapted to hold or support a quantity of wet pet food, whereby the pet owner or consumer: (i) grasps and holds the handle portion 48; (ii) dips the dipping portion 50 in the wet pet food; (iii) extracts a quantity of wet food from its compartment onto the flat surface 52; (iv) maneuvers the pet food combination via the handle portion 48; and (v) feeds either the wet food or the dry food/wet food combination to the pet.

The wet pet foods, such as wet foods 44 and 46, can include any type of commercially available wet pet food but preferably are highly palatable sauces, gravies and/or pastes. The sauces or pastes are formulated with oils, fats and other dry materials, so that the wet pet food is shelf stable and requires no preservatives. The sauces, gravies and pastes are palatability boosters and/or nutritional supplements. The nutritional supplements include, among other items, vitamins, minerals, prebiotics and probiotics, etc.

As stated above, the tray 20 of the container 10 includes any number of wet food compartments. The tray 20 likewise includes any combination of pastes and sauces. The dry dipping unit 42 preferably includes an indentation 54 when the container 10 packages sauces or thinner pastes. The flat surface 52 suffices for thicker pastes.

The tray is filled sequentially with the wet and then the dry components, preferably under a protected atmosphere. The atmosphere should be both oxygen and moisture-free. Those skilled in the art are well versed in using a dry, inert gas, such as nitrogen, to blanket an area of the packaging process where the wet and dry components fill into the tray.

The container 10 as herein disclosed provides a self-contained and portable method and apparatus for providing highly palatable and nutritional pet food snacks to pets. The container 10 enables the pet owner to transport the container to a park, etc., provide a portion of the nutritional dry food 42 and one or more wet foods 44 or 46, reseal the unused pet food and transport the container 10 home for future use. Each of the shelf stable pet food snacks is sufficiently sealed within the container 10 so that individual packaging is not necessary. Providing the pet food snacks of the present invention to the pet therefore produces virtually no waste, which further enhances the portability of the container 10.

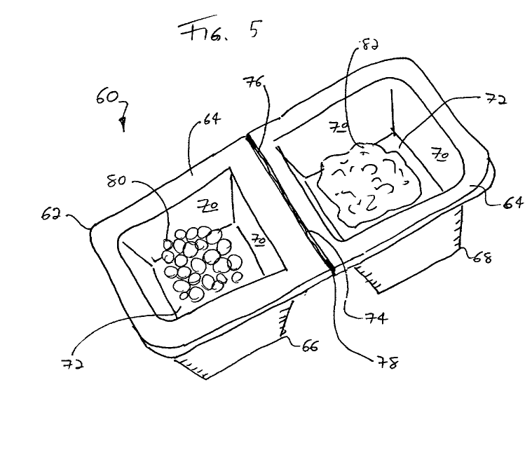

Referring now to FIG. 5, an alternative embodiment of the present invention is illustrated by the container 60. The container 60 is constructed of any of the materials described above in connection with FIG. 1. The container 60 includes a tray 62 that defines a tray surface 64. A plurality of compartments 66 and 68 extend from the tray surface 64. Each of the compartments 66 and 68 include side walls 70 and a bottom wall 72. Container 60 may include any number of compartments greater than one and is not limited to the two illustrated compartments.

At least one pair of compartments, such as compartments 66 and 68, reside on opposite sides of a hinge 74, defined by the surface 64, so that the compartments of the pair mate with one another when the container 60 is folded along the hinge 74. The hinge 74 may simply be a crease in the tray surface 64 although more elaborate hinges may be provided as is well known in the art. The hinge in an embodiment is slit along the sides 76 and 78 a suitable distance to facilitate folding the container 60. The compartments of the pair can, but do not have to be, the same size. A single compartment on one side of the hinge 74 may be adapted to mate with any number of compartments disposed on the opposite side of the hinge 74.

One type of pet food is placed in a compartment on one side of the hinge 74, while another type is placed on the opposite side. When the container 60 is opened and folded along the hinge 74, the different types of pet foods mix to form a desired pet food combination. In the illustrated embodiment, the container 66 includes a dry or semi-moist product 80. The dry food product 80 may be any type of dry pet food described above and have the shape disclosed in connection with FIGS. 3 and 4. The dry food 80, as illustrated, is alternatively provided in smaller sized portions, such as nuggets, pellets, kibbles, etc.

In the illustrated embodiment, the container 68 includes a wet pet food product 82. The wet food product 82 may be any type of wet pet food described above. The wet pet food may alternatively include water or milk. A cover (not illustrated) covers both compartments 66 and 68. The container 60 in an embodiment is packaged in the unfolded position, as illustrated in FIG. 5. The container 60 is alternatively packaged folded along the hinge 74, e.g., to save space, etc., wherein container 60 is unfolded, opened (cover removed) and refolded.

It should be appreciated that container 60 may alternatively include a pair of opposing compartments that house two different types of dry or semi-dry pet food products. Container 60 may further alternatively include a pair of opposing compartments that house two different types of wet pet food products.

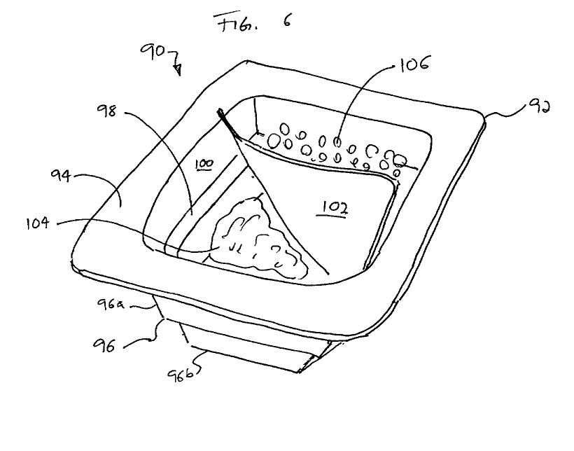

Referring now to FIG. 6, an alternative container 90 having vertically stacked food components is illustrated. The container 90 is constructed of any of the materials described above in connection with FIG. 1. The container 90 includes a tray 92 that defines a tray surface 94. One or more compartments, such as the compartment 96, extends from the tray surface 94. Each of the compartments includes a rim 98 which extends around the side walls 100 of the compartment. Container 90 may include any number of the rimmed or tiered compartments and is not limited to the one illustrated compartment 96.

A divider 102 illustrated partially peeled back seals directly to the rim 98 so as to divide the compartment 96 into an upper sub-compartment 96a and a lower sub-compartment 96b. The seal can include a heat or induction seal or employ an adhesive suitable for consumable pet food packaging. It should be appreciated that container 90 may be modified to include a plurality of rims, such as rim 98, to create more than two sub-compartments.

The sub-compartments 96a and 96b house different types of food products as described above. In an embodiment, the lower sub-compartment 96b houses a wet food product 104 that includes any of the wet pet food products described above, while the upper sub-compartment 96a houses a dry food product 106 that includes any of the shapes and types of dry pet food products described above. In this embodiment, the dry food 106 is removed from the upper sub-compartment 96b, the divider 102 is opened and/or removed and either: (i) the wet food 104 is poured into a separate container that currently holds the dry food 106; or (ii) the dry food 106 is poured back into the container 90 and mixed with the wet food 104.

In an alternative embodiment, the lower sub-compartment 96b houses the dry food 106, while the upper sub-compartment 96a houses a wet food product 104. In one implementation, the wet food 104 is of such a viscosity that the divider 102 may be perforated or torn so that the wet food runs through the divider 102 to the lower sub-compartment 96b. The lower sub-compartment 96b contains enough space so that all the wet food 106 drains through, whereby the divider may be removed.

A cover (not illustrated) covers the compartment 96 on the surface 94 of the tray 92. The divider 100 and the cover are each, in an embodiment, a thin plastic or moisture impermeable sheet or other sheet material that is coated with a plastic or moisture impermeable layer. In an alternative embodiment, the surface 94 of the tray 92 defines a pair of compartments on either side of a crease (FIG. 5), so that one multi-food compartment may fold over another multi-food compartment.

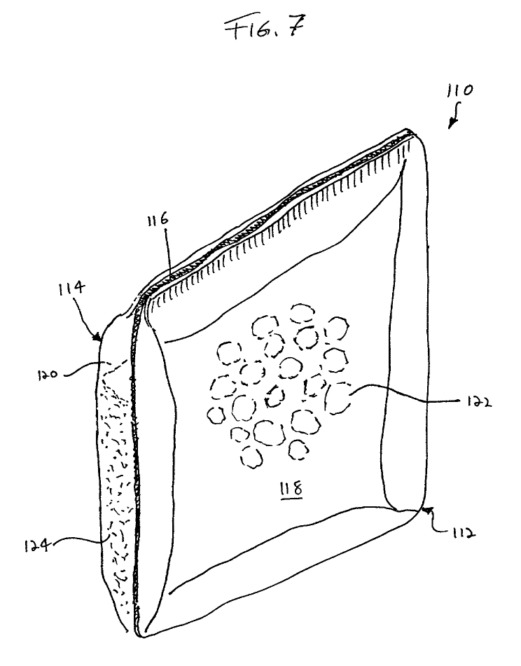

Referring now to FIG. 7, an alternative flexible pouch container 110 is illustrated. The flexible pouch container 110 is made of any suitable flexible, moisture impermeable material such as a plastic sheet, thin metal foil or other material coated with plastic or a thin metal foil. The container 110 defines a plurality of separate compartments 112 and 114, which are separated by a flexible, moisture impermeable divider 116 made of a suitable material as disclosed above. The divider 116 is therefore a wall common to both the compartments 112 and 114. The divider 116 is illustrated as being disposed substantially parallel to the faces 118 and 120 of the compartments 112 and 114, respectively. The divider 116 may alternatively be disposed substantially perpendicular to the faces 118 and 120 of the compartments 112 and 114.

The compartments 112 and 114 house different types of pet food products as disclosed above. In the illustrated embodiment, compartment 112 holds a dry or semi-dry food product 122, while compartment 114 holds a wet food product 124. As before, the compartments 112 and 114 may alternatively both house different dry or semi-dry food products or different wet food products.

In an embodiment, the divider 116 is at least partly removable to allow communication between the products 122 and 124 of the compartments 112 and 114 and at least some pre-mixing of the products prior to dispensing. In one implementation, the divider 116 is removable by exertion of pressure on one or both of the faces 118 and 120 which is sufficient to rupture the divider 116. The divider seal is therefore of less strength than that of the external faces 118 and 120 of the compartments 112 and 114 of the container 110.

In another embodiment the faces 118 and 120 peel away from the divider 116 so that the products 122 and 124 can pour simultaneously into a separate container. In a further alternative embodiment, the container 110 includes two completely separate pouch compartments (not illustrated), i.e., not separated by a divider 116 but attached along a common edge instead. Here, the separate compartments each include a seal that is broken to pour out the products.

Any of the embodiments for the flexible pouch container 110 may be split into any number of separate compartments using multiple dividers 116 or by providing multiple completely separate compartments. Further, one or more of a pair of completely separate compartments attached along a common edge may include a divider 116, so that three or more food products can be mixed and dispensed.

It should be understood that various changes and modifications to the presently preferred embodiments described herein will be apparent to those skilled in the art. Such changes and modifications may be made without departing from the spirit and scope of the present invention and without diminishing its attendant advantages.

1. A pet food container including pet food comprising:
a tray;
a dry food compartment defined by the tray and including a unit of dry pet food;
a wet food compartment defined by the tray and adapted to receive unpackaged wet pet food; and
a quantity of wet pet food in the wet pet food compartment.

2. The pet food container of claim 1, wherein the dry pet food compartment is spatially adapted to maintain a number of dry pet food units in a packaged order.

3. The pet food container of claim 1, wherein the dry food compartment includes a plurality of dry pet food units.

4. The pet food container of claim 1, wherein the wet pet food is a flavored cream paste.

5. The pet food container of claim 1, wherein the wet pet food is shelf stable.

6. The pet food container of claim 1, wherein the dry pet food includes functional foods.

7. The pet food container of claim 1, which includes a second wet food compartment formed in the tray having a quantity of a second wet pet food.

8. The pet food container of claim 1, which includes a resealable lid.

9. The pet food container of claim 1, which includes a hinge in the surface positioned so that one of the compartments may be folded over onto the other compartment.

10. A pet food container comprising:
a tray defining a surface;
a plurality of pet food compartments that each extend from the tray surface, the pet food compartments individually adapted to hold a particular quantity and type of pet food, wherein at least one pet food compartment is moisture impermeable and contacts a wet pet food product; and
a resealable lid removably attached to the container, the lid adapted to seal the compartments from ambient air.

11. The pet food container of claim 10, wherein the tray is made of a material chosen from the group consisting of: cardboard and plastic.

12. The pet food container of claim 10, wherein the tray includes a functional food.

13. The pet food container of claim 10, wherein the resealable lid is adapted to individually seal at least one compartment.

14. The pet food container of claim 10, which includes a crease in the surface positioned so that a compartment may be folded over onto another compartment.

15. A pet food container including pet food comprising:
a body, including a tray that defines a surface and includes at least two compartments that each extend from the surface;
a unit of dry pet food stored in one of the compartments, the dry pet food including an end having a surface adapted to hold a quantity of wet pet food; and
a unit of wet pet food stored in a second compartment.

16. The pet food container of claim 15, wherein the dry pet food end has a rounded shape.

17. The pet food container of claim 15, wherein the dry pet food end has a rectangular shape.

18. The pet food container of claim 15, wherein the dry pet food has a spoon shape.

19. The pet food container of claim 15, which includes a plurality of different wet pet food quantities stored in the tray, wherein the dry pet food surface is adapted to individually hold a quantity of each wet pet food.

20. A dry pet food product that includes a body having a first end and a second end, the first end including an indentation for receiving a wet pet food product.

21. The dry pet food of claim 20, wherein the body has a substantially rectangular shape.

22. The pet food product of claim 20, wherein the dry pet food product has a spoon like shape.

23. A method for providing a pet food product comprising the steps of:
providing a container housing a plurality of pet foods, including dry pet food units and a first wet pet food, wherein the dry pet food units have a surface adapted to hold a quantity of the first wet pet food:
removing a dry pet food unit;
using the dry pet food unit to remove a quantity of the first wet pet food; and
providing the dry pet food unit including the wet pet food to a pet.

24. The method of claim 23, wherein the container houses a second wet pet food, using the dry pet food unit to remove a quantity of the second wet pet food.

25. A pet food container for holding different pet foods comprising:
a tray;
a compartment defined by the tray; and
a removable divider that separates the compartment into sub-compartments so that one sub-compartment holds a quantity of a first pet food and the other sub-compartment holds a quantity of a second pet food.

26. The container of claim 25, wherein the tray defines a plurality of multi-food compartments that each receive a divider and separate first and second pet foods.

27. The container of claim 26, which includes a hinge in the surface positioned so that a multi-food compartment may be folded onto another multi-food compartment.

28. The container of claim 25, which includes a plurality of dividers that form at least three different sub-compartments.

29. A pet food container for holding different pet foods comprising:
a tray;
a first compartment defined by the tray and including pet food;
a second compartment defined by the tray and including pet food; and
a hinge located between the compartments to allow one compartment to be moved relative to the other compartment.

30. The pet food container of claim 29, wherein the hinge is so constructed and arranged to allow one of the compartments to be folded over onto the other compartment.

31. A pet food container for holding different pet foods comprising:
a flexible pouch;
a first compartment defined by the pouch for holding a first pet food; and
a second compartment defined by the pouch for holding a second pet food.

32. The container of claim 31, wherein the pouch includes two outer faces and a divider sealed between the faces.

33. The container of claim 31, wherein the first and second compartments are attached to each other along a common edge.

34. The container of claim 33, wherein the compartments each include outer faces and a divider sealed in between the faces.
